(19) United States
(12) Patent Application Publication
(10) Pub. No.: US 2009/0014161 A1
(43) Pub. Date: Jan. 15, 2009

(54) CONTAINER ARRANGEMENT

(75) Inventor: Aleksandar Mihajlovic, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/095,123

(22) PCT Filed: Nov. 15, 2006
(86) PCT No.: PCT/SE06/01293

§ 371 Date: Sep. 3, 2008

(30) Foreign Application Priority Data
Nov. 28, 2005 (SE) 0502608-3

(51) Int. Cl. F02B 29/04

(52) U.S. Cl. 165/148

(57) ABSTRACT

A charge air cooler (CAC) with at least one water condensate storage container reducing the risk of ice forming a plug inside the CAC and hindering flow of air is provided. The storage container is formed by a storage container mounted inside a CAC air distribution compartment forming two sections wherein the upper section is used for storing condensed water and distributing air into a cooling section of the CAC, and a bottom section that is arranged to distribute air flow so as to provide an efficient heat exchange with ice and water in the storage container and a free passage of air flow. The storage container may include a plurality of separate successive storage sections, each successively used when one storage section is full of water and/or ice.

### FIELD OF THE INVENTION

The present invention relates to a container arrangement, preferably for a CAC (Charge Air Cooler) and in particular to a condensation water container in connection to the CAC.

### BACKGROUND OF THE INVENTION

Charge air coolers (CAC), sometimes denoted as intercoolers, are often used in association with turbo charged engines for instance in heavy duty diesel engines. The CAC cools charge air from the turbo compressor in order to increase the amount of oxygen available per volume unit which in turn leads to a better combustion, lower temperature within the combustion chamber, and lower fuel consumption. However, in the cooling process the water present in the compressed air may condensate and be collected at a lower part of the CAC. This water can, if outside temperatures are below freezing, freeze to ice and in case of large amount of water form a plug which obstructs the air flow entirely.

Depending on the type of CAC, it may be placed differently within the engine area in the vehicle containing the engine. For instance an air cooled CAC need to have free air passage either directly or through an air duct system or in the case of a water cooled CAC it may be placed in any suitable location adjacent to the engine.

### SUMMARY OF THE INVENTION

It is an object of the present invention to provide a charge air cooler that remedies some of these problems. This is achieved according to a first aspect of the present invention:

A charge air cooler (CAC) comprising:
a housing,
an air inlet;
an air distribution compartment connected to the housing;
a cooling section; and
an air outlet,
   wherein air enters into the housing through the air inlet and exits through the air outlet passing the cooling section, characterized in that the air distribution compartment comprises at least one water condense container for holding condensed water and air distribution channels for distributing air connected to the air inlet, which channels are arranged to distribute air in such a way that the air interacts with the condense water container positioned above the air distribution channels.

The channels may further comprise air flow steering structures. The air inlet may comprise an air dividing structure, dividing air proportionally to any asymmetry in location of the air inlet.

The container may further comprise at least one rim dividing the container into separate water holding sections. The water condense container may comprise at least one drainage hole.

Another aspect of the present invention is provided, a vehicle with a charge air cooler according to above described example.

Yet another aspect of the present invention, an air distribution compartment for use in a charge air cooler (CAC) is provided, comprising:
an air inlet;
at least one air distribution channel;
any least one water condense container;
   wherein the water condense container is positioned adjacent to the at least one air distribution channel and the air inlet, providing air to the air distribution channel, and the water condense container has a water holding shape.

Still another aspect of the present invention, a method of manufacturing a charge air cooler (CAC) is provided, comprising the steps of:
assembling a cooling section in a housing;
connecting an air distribution compartment to the housing;
assembling an air inlet to the air distribution compartment;
assembling an air outlet to the housing; and
providing at least one water condense container for holding condensed water and at least one air distribution channel in the air distribution compartment, wherein the container is positioned adjacent to the channels.

Yet another embodiment of the present invention, a media separation system comprising
a separation device,
an inlet;
a distribution compartment connected to the separation device; and
an outlet,
   wherein a composition of materials enters into the inlet and exits through the outlet with a change of composition ratio, wherein the separation device separates the composition into at least two parts, a first part that continues to the outlet and a second part that is collected in the distribution compartment, and the distribution compartment comprises at least one container for collecting the second separated part.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates a charge air cooler (CAC) according to the present invention wherein FIG. 1a shows the CAC in a front view and FIG. 1b is a side view;

FIG. 2a illustrates a frontal cross-sectional view of an air distribution compartment with a water condensation container of the charge air cooler in FIG. 1a;

FIG. 2b illustrates a cross section through a portion of the tank of FIG. 2a in a view from above;

FIG. 2c illustrates the tank of FIG. 2a in a side view;

FIG. 3 illustrates another embodiment of the present invention; and

FIG. 4 illustrates yet another embodiment of the present invention in two different views.

### DETAILED DESCRIPTION OF THE INVENTION

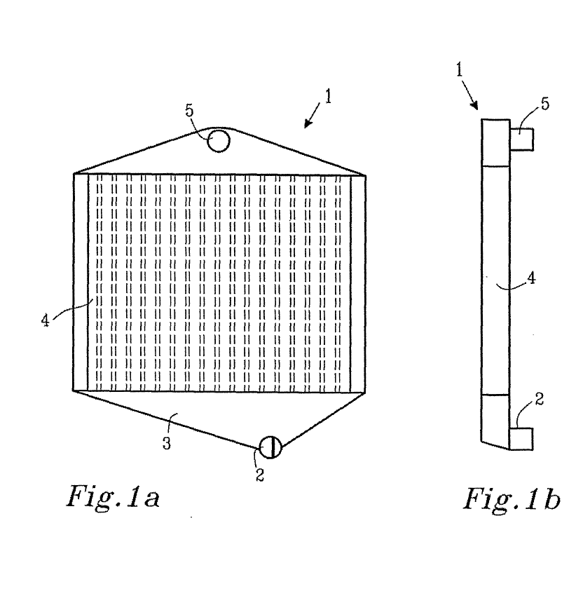

FIG. 1 illustrates a charge air cooler (CAC) unit 1, for a vehicle engine, according to the present invention. The CAC unit 1 comprises an air inlet 2, an air distribution compartment 3 normally integrally mounted to a cooling section 4 in turn integrally formed with a top part 5 of the unit 1 and finally an air outlet 5; the cooling section is mounted within a housing. The function of the CAC 1 is as follows: warm air enters through the air inlet 2 (from a turbocharger or directly from the outside via a filter) and enters into the air distribution compartment 3 of the CAC 1. Beneath the CAC and inside the air distribution compartment 3 an air distribution channel (not shown in FIG. 1) is located. A cooling section 4, e.g. comprising spaced, vertically extending tubes, between which are disposed serpentine cooling fins, oriented to permit air flow through the unit, is provided wherein air acting on the outside of the cooling section 4 or water contained in a piping system in heat contact with the cooling section 4 cools the air and finally the air exists through the air outlet 5 for use in a combustion process of the engine; the cooled air can for instance be used in a mixing device (not shown) for mixing fuel and air or for direct injection into a combustion chamber of the engine. The air distribution compartment 3 is provided in order to distribute air evenly or in a suitable manner in to the cooling section 4 so as to cool air as efficiently as possible.

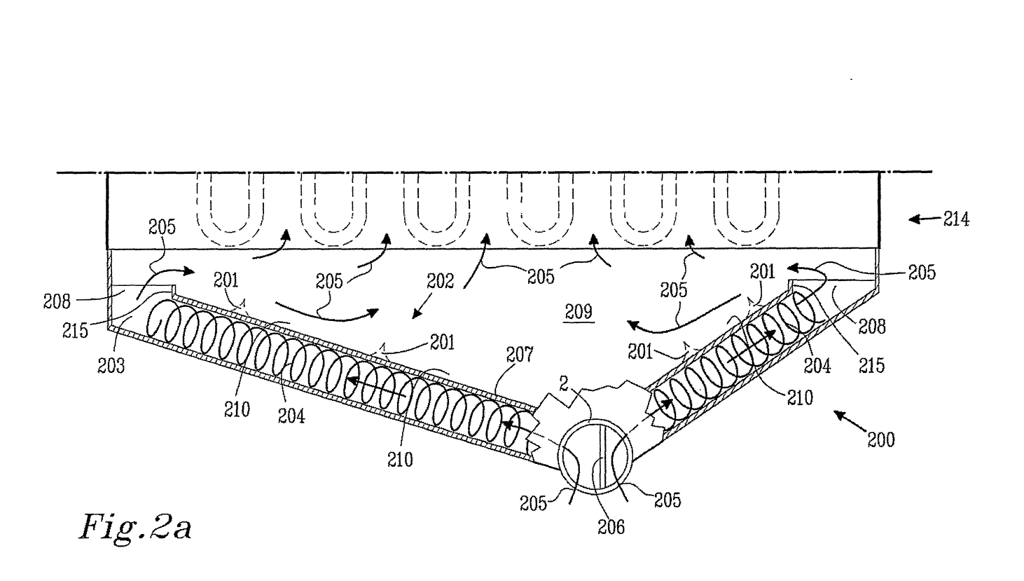

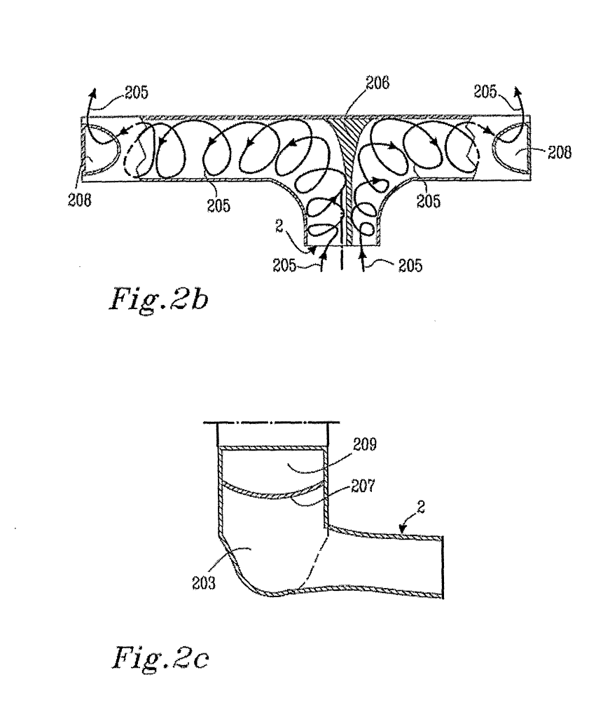

FIG. 2a illustrates a cross sectional frontal view of a CAC condense collector tank and air distribution compartment 200 according to the present invention in detail. The CAC tank 200 comprises a substantially V or U-shaped lower portion and an arrangement for distributing air in a suitable manner into the cooling section 214 of the CAC 1 and thus provides a water condensate storage volume in order to receive water from the cooled air condensed during the cooling process. This water flows (drops) downwards from an upper side 209 and is collected in the lower portion 203 of the tank If the vehicle is exposed to a freezing environment there is a risk that the water freezes and thus may form a plug, which hinders the flow of the air. In order to reduce this risk, the tank according to the present invention comprises a water storage arrangement 202 arranged adjacent to the substantially V or U-shaped bottom of the tank 200 forming one or several, e.g. two levels in the tank 200. This storage arrangement 202 is formed comprising a storage container(s) 207 shaped so as to form a water holding structure, i.e. with a center portion (bottom of V or U) positioned lower than the sides of the container. This lower portion may be located in a center or off center position, e.g. as seen in FIG. 2a. In this case the air inlet 2 constitutes the extreme bottom of the tank. According to this exemplary embodiment, below the storage container 207 is arranged one or several channels 203 connected to the air inlet 2 and comprises exits 208 at two end parts along the long side of the tank 200. These two exits 208 are air flow openings allowing air to flow from the bottom side 203 to the upper side 209 of the tank 200. The exits 208 comprise an extension 215 for blocking the condensed water to ooze into the exits 208.

Optionally, air flow steering units 204 in the channels 203 may be provided in order to steer the air flow in a suitable manner for increasing the heat exchange with any ice present in the tank 200. The air steering units 204 may be formed for instance as a spiral structure or any other suitable structure steering the flow of the air in such a way so as to enhance the heat exchange between air and the storage container 207.

FIGS. 2b and 2c show schematically a cross-sectional top view and side view, respectively, of a part of the CAC tank and distribution compartment 200 in FIG. 2a.

An air dividing structure 206 may be provided in connection with the air inlet 2 in order to distribute the flow of air proportionally in accordance with the placement of the air inlet 2 with respect to the CAC tank 200. This to ensure an even distribution of air in relation to the asymmetry of the air inlet 2 with respect to the tank as seen in FIG. 2a, i.e. the short channel on right side of the drawing needs less air than the longer channel on the left side and thus more air is allowed to the left side (with respect to the plane of the drawing).

The function of the CAC tank according to the above embodiment is as follows: Air (air flow directions denoted with 205) enters into the air inlet 2 and is distributed proportionally with the air dividing structure 206. Air flows under the storage container 207 in the channels 203 of the tank 200 and warms the container 207 and melts any ice present in the storage container 207. The air flow continues its path and enters the upper part 209 of the tank through the air flow openings 208 and continues to heat and melt any ice located in the storage container 207 and flowing into the cooling section 214 through a plurality of openings (not shown) into a heat exchange structure (not shown) located inside the cooling section 214. When the ice is melt and dissolved and simultaneously is transformed into water, the heating process continues as the air flows under the storage container 207 in the channels 203 and the water vaporizes. The storage container 207 is thus empty of water after some time when the air has flowed in the channels 203.

When the engine has stopped and in a situation where the vehicle is located in a freezing environment any water present in the CAC will be collected in the storage arrangement 202 and due to the cold environment it will freeze to ice. However, since the water/ice is located in the storage arrangement 202 it will not form a plug hindering the flow of air when the engine restarts.

According to a second embodiment, the storage arrangement 202 comprising the storage container 207 may be divided into several separate successive sections 210 by means of one or several water separating rims 201 each holding a certain volume of water. When each successive section 210 is full any additional water will flow over the water separating rim 201 into the next water holding section 210.

The storage container 207 may comprise any suitable material as appreciated by the person skilled in the art, such as, but not limited to metal (e.g. aluminum, steel, zinc, or titanium), plastics, ceramics, or composites thereof.

The storage container 207 may be formed by taking a suitable flat sheet of material and pressing it into place in its intended position, securing the storage container 207 with glue, one or several screws, or other fastening devices (e.g. hooks or clips) or just press fitted to stay in place. When the tank is positioned together with the cooling section 4 one or several spacers (not shown), e.g. of different heights, may hold the structure by pressing part of the storage container downwards and keeping it in place and securing the shape of the storage container 207. These spacers may be advantageous for instance if the storage container is mounted by press fitting. The container 207 may also be produced in a pre formed shape, mounted in the intended position and secured with similar means as described above. The container 207 may be manufactured in one piece or several pieces mounted during assembly of the CAC.

With this solution condensed water is hindered from reaching the inlet 2 of the CAC 1 and thus the risk of ice forming a plug is greatly reduced as compared to conventional methods. Also due to the air steering structures 204, warm air is better distributed within the tank volume and thus providing a better heat exchange when melting ice and/or vaporizing water.

The tank 200 may be provided with one or several drainage holes (not shown) for removing surplus water if necessary. This drainage hole may advantageously be located at the bottom part of the storage container 207 and with a drainage canal out to a tap providing exterior access. A drainage canal may be provided within each successive section 210 divided by the rims 201 of the container 207 in order to drain water separately in each section or levels if several levels of containers 207 are provided.

With the solution according to the present invention it is possible to upgrade existing CAC solution with an add-on that may be mounted in an existing CAC tank solution. The add-on part, for instance a pre formed storage container 207, can be mounted in place inside conventional CACs by removing the lower part of the CAC, fitting the container 207, and refitting the lower part of the CAC. Depending on CAC system being upgraded or retrofitted, the lower part may be needed to be replaced with a new larger part in order to fit the storage container 207.

The air inlet 2 is located in the case as seen in FIG. 2a at the bottom of the CAC system, thus at the bottom of the CAC tank; however, the inlet 2 may be located in other positions as understood by the person skilled in the art and may comprise a plurality of air inlets distributed in a suitable manner.

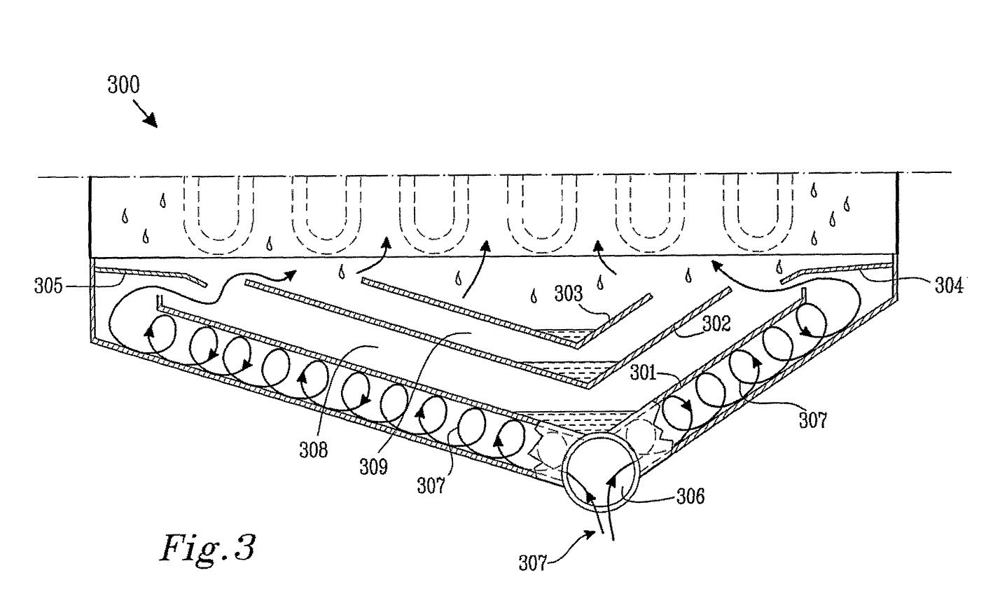

Turning now to FIG. 3, wherein another embodiment of the present invention is illustrated. The CAC tank 300 comprises in this case a plurality of containers 301, 302, 303 in order to even further enhance the storing capacity of separated water. Just as in the case above illustrated in FIG. 2, the CAC tank 300 has an inlet 306 (which may have a dividing structure (not shown)). Air is guided through channels 307, 308, 309 and further up to the CAC itself. It is also possible to have condensation guiding structures 304 and 305 for guiding condensed water from the CAC to enter one of the containers 301, 302, 303 and hindering water from entering into the first channel 307 and possibly blocking the inlet 306. Such guiding structures 304 and 305 may also be present in the embodiment shown in FIG. 2 of course, as should be appreciated by the person skilled in the art. The number of container levels 301, 302, and 303 is not limited to the three shown but can be any suitable number from 1 and up depending on application and geometrical structure of the volume wherein they have been mounted.

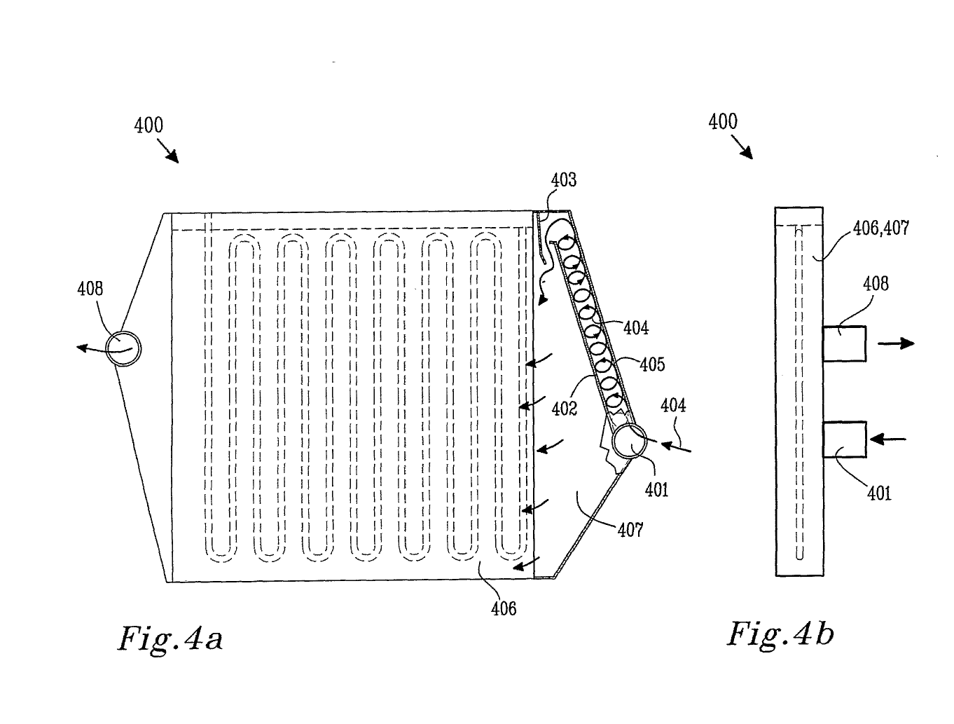

Turning now to FIGS. 4a and 4b where yet another embodiment of the present invention is illustrated, with FIG. 4a illustrating a cross sectional frontal view and FIG. 4b a side view. In this case the CAC 400 with air distributing compartment 407 is arranged in a horizontal position. In FIG. 4 air is let in through an inlet 401 and guided through a channel 404 along a dividing structure 402 and an outer wall 405 together forming the channel 402. A channel protection structure 403 may be provided for steering air downwards and stopping back flow of particles and/or fluids into the channel 404. The CAC 400 comprises further of a cooling section 406 and an outlet 408 where cooled air is provided for use in the combustion process.

Different ways of manufacturing the charge air cooler 1 (or 400) may be used as may be understood by the person skilled in the art, such as pre-fabricating the container 207 in different shapes for fitting in different vehicle types or versions, or type and version of CAC. A method for manufacturing/assembling a CAC will now be discussed with reference to a pre-fabricated container 207:
assembling an air inlet 2 in a housing;
connecting an air distribution compartment 3, 200 (or 407) to the housing;
assembling a cooling section 4, 214 (or 406) to the housing;
assembling an air outlet 5 (or 408) to the housing; and
providing a water condense container 207 for holding condensed water and air distribution channels 203 to the air distribution compartment 3, 200 (or 407).

The order of the above described steps can be changed as understood by the person skilled in the art.

The same type of container arrangement for handling condensed water as described above may be applicable to other variations of fluid or particle separation from an air or gas stream. Actually it can also be applicable to handling fluid or particle pollution in for instance an oil stream. The key effect here is that, in this case, the difference in density and/or in the fact that the stream flow is such as to separate material with different densities. A stream of a composition of material is provided with a certain flow speed, and particles or fluids are part of this composition together with a bulk material comprising the major part of the composition. The different constituents of the composition have different densities and will therefore be affected differently by the stream flow, for instance in the embodiments illustrated by FIGS. 2 and 3 gravity will affect some of the constituents in such a way as to counteract the stream flow of these constituents and they will fall downwards into the container 207 or containers 301, 302, and 303 while the bulk of the stream will continue along the general flow direction.

In some applications the particles or fluids to be separated from the bulk material are collected into larger aggregates such as for instance droplets which are so heavy that the general flow speed is not enough to drag the aggregates along but instead the aggregates fall down due to gravity. This is true for the first embodiment described above concerning water condensing in the CAC when air (containing moisture) is being cooled. The invention may be utilized for collecting particles or fluids coming from a process where it is of desire to obtain such particles or fluids or from processes where particles or fluids are aggregated as a byproduct (e.g. as in the case of the CAC solution described above, where water is condensed in the process of cooling air).

The word “air” in this document means any type of gas composition as understood by the person skilled in the art.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, and that several “means” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A charge air cooler (CAC) comprising:
a housing,
an air inlet;
an air distribution compartment connected to the housing;
a cooling section; and
an air outlet,
wherein air enters into the housing through the air inlet and exits through the air outlet passing the cooling section, wherein the air distribution compartment comprises at least one condensed water container for holding condensed water and air distribution channels for distributing air connected to the air inlet, which channels are arranged to distribute air in such a way that the air warms the condensed water container positioned adjacent to the air distribution channels for melting any ice present in the condensed water container.

2. The CAC according to claim 1, wherein the channels further comprise air flow steering structures.

3. The CAC according to claim 1, wherein the air inlet comprise an air dividing structure, dividing air proportionally to any asymmetry in location of the air inlet.

4. The CAG according to claim 1, wherein the condensed container further comprise at least one rim dividing the condensed water container into separate water holding sections.

5. The CAC according to claim 1, wherein the condensed water container comprises at least one drainage hole.

6. A vehicle with a charge air cooler according to claim 1.

7. An air distribution compartment for use in a charge air cooler (CAC), comprising:
an air inlet;
at least one air distribution channel;
at least one condensed water container;
wherein the at least one condensed water container is positioned adjacent to the at least one air distribution channel and the air inlet, providing air to the air distribution channel, and the condensed water container has a water holding shape, and the air distribution channel is arranged to distribute air in such a way that the air warms the condensed water container for melting any ice present in the condensed water container.
